(19) United States
(12) Patent Application Publication
(10) Pub. No.: US 2010/0269627 A1
(43) Pub. Date: Oct. 28, 2010

(54) BICYCLE HANDLEBAR GRIP

(75) Inventor: Franc Arnold, Koblenz (DE)

Correspondence Address: OHLANDT, GREELEY, RUGGIERO & PERLE, LLP, ONE LANDMARK SQUARE, 10TH FLOOR, STAMFORD, CT, 06901, US

(73) Assignee: RTI Sports Vertrieb von Sportartikeln SmbH

(21) Appl. No.: 12/765,529

(22) Filed: Apr. 22, 2010

(30) Foreign Application Priority Data
Apr. 23, 2009 (DE) 20 2009 005 939.1

(51) Int. Cl. B62K 21/26

(52) U.S. Cl. 74/551.9

(57) ABSTRACT

A bicycle handlebar grip, particularly suited for trekking bikes and mountain bikes, comprises a grip element to be mounted on a handlebar tube. Further, there is provided an additional grip element, such as, e.g., a barend, which is arranged at an angle to the grip element. The attachment of the additional grip element and of the grip element is realized by a common clamp which is preferably tightly attached to the additional grip element. The clamp comprises a first clamping region for connection of the additional grip element directly on the outer side of the handlebar tube. By a second clamping region, the additional grip element is connected to the grip element. In the assembled state, a securing element is arranged in the second clamping region.

### BACKGROUND OF THE INVENTION

1. Field of the Invention

The present invention relates to a bicycle handlebar grip, particularly a handlebar grip for trekking bikes and mountain bikes.

2. Description of the Prior Art

Bicycle handlebar grips comprise e.g. a cylindrical, preferably slotted sleeve, wherein said sleeve is fastened to the bicycle handlebar with the aid of a clamping means. The clamping means is effective to press the slotted sleeve together, resulting in a clamping attachment of the bicycle handlebar grip to the bicycle handlebar.

From WO 2005/021366, there is known a bicycle handlebar grip wherein a grip element comprises a slotted sleeve to be shifted onto a bicycle handle-bar. Said sleeve is connected to a grip portion made of a preferably softer plastic material. Further, the sleeve comprises a clamping region provided preferably on the outer side of the grip. For fastening the handlebar grip to the handlebar, a clamping means, formed as a grip horn or barend, will be arranged in such a manner that a clamping region of said clamping means surrounds the clamping region of the sleeve. With the aid of a screw, the sleeve will then be clamped to the bicycle handlebar.

Known from U.S. Pat. No. 6,263,759 is a bicycle handlebar grip comprising a grip horn. This bicycle handlebar grip comprises a sleeve made of relatively stiff material and provided to be shifted onto the end of the handlebar, which sleeve is surrounded by a grip portion made of soft material. For positional fixation of the sleeve, the sleeve is on both of its ends provided with projections extending in the longitudinal direction. Said projections engage annular clamping means which are likewise arranged on both sides of the handlebar grip. Said two clamping means have an annular shape and are provided with a radial slot. The clamping attachment is performed by reducing the width of the slot with the aid of a screw. The handlebar horn is separately connected to the handlebar by a further clamping attachment.

In case of relatively long grip horns, considerable forces and moments may happen to occur in the region of the clamping attachment, particularly when a mountain bike is being rode in open terrain. This may have the consequence that the grip horn becomes twisted. Particularly if the grip horn serves as clamping means and surrounds a sleeve made of plastic or the like, the material of the sleeve may be caused to creep. Twisting of the grip horn involves a massive safety hazard.

One approach for avoiding a twisting of the grip horn or barend, known from DE 20 2007 012 180, resides in the provision of two clamping regions on said clamping means connected to the barend, wherein, in the mounted state of the barend, a first of said two clamping regions is directly connected to the handlebar tube. In this manner, the barend is clampingly fixed to the handlebar via said first clamping region. A second clamping region, following the first clamping region in the axial direction or the direction of the handbar tube, serves for fixation of the grip element. Herein, a slotted sleeve of the grip element is arranged to project into the second clamping region so that, via the sleeve of the grip element, the grip element is clampingly held in position. In this arrangement, a toothing extending in the longitudinal direction can be provided in the second clamping region. By such an axial toothing, undesired twisting of the bicycle grip relative to the handlebar horn is avoided. This is useful if the bicycle grip comprises a wing-shaped support portion for the heel of the hand because said support portion may be subjected to considerable forces. Forces acting on the support portion can cause a twisting of the grip on the handlebar tube. This is a considerably safety risk. However, such an axial toothing disadvantageously makes it impossible to perform a fine adjustment between the bicycle grip and the grip horn. Especially in a bicycle grip with support portion, it must be possible to fine-adjust the position of the bicycle grip on the handlebar tube. During use of the bicycle, it is often perceived by the cyclist that a slight rotation of the bicycle grip about the handlebar will achieve a better ride feel and e.g. will exert less stress onto the heels of the hand, thus preventing the hand from going numb. Such a slight rotational adjustment, however, is difficult if an axial toothing is provided because the user will first have to loosen the grip horn and then will have to pull apart the grip horn and the bicycle grip in order to rotate the toothing by one tooth. On the one hand, this is a bothersome process and, on the other hand, a fine adjustment can still not be achieved because there will be possible only a stepwise adjustment in dependence on the spacing between the teeth.

It is an object of the present invention to provide a bicycle handlebar grip, particularly of a type suited for trekking bikes and mountain bikes, wherein a safe connection is guaranteed between a grip element and an additional grip element such as e.g. a grip horn or barend.

### SUMMARY OF THE INVENTION

According to the invention, the above object is achieved by the features defined in claim 1.

The bicycle handlebar grip according to the invention comprises a grip element which, as is the case in conventional bicycle handlebar grips, can be shifted onto a handlebar tube. Said grip element can be of a multi-part design and can particularly comprise a sleeve made of a harder material, particularly harder plastic. Said sleeve can be surrounded by a grip portion which likewise is made of plastic, particularly softer plastic. Said two parts of the grip element are tightly connected to each other, e.g. by vulcanizing. If the grip element comprises a sleeve or a similar cylindrical attached piece, it is preferred that said sleeve or attached piece, at least in its edge region, is slotted in the longitudinal direction of the grip element. In this arrangement, it is especially preferred that a clamping attachment of the grip element is realized by the slotted region of the sleeve and respectively the slotted projection.

The bicycle handlebar grip of the invention comprises, in addition to the grip element, an additional grip element which preferably is a grip horn or barend. Said additional grip element is arranged at an angle to the grip element. Said angle is larger than 0° and smaller than 180° and normally is in the range from 45° to 135°. In the bicycle handlebar grip of the invention, the additional grip element is connected to a clamping means, said clamping means being preferably undetachably connected to the additional grip element or integrally formed with the additional grip element. Preferably, the clamping means is provided with a slot extending in the longitudinal direction, preferably along the clamping region of the clamping means. The clamping force is preferably generated by a clamping element such as e.g. a screw arranged in the region of the slot, wherein a tightening of said screw will effect a reduction of the slot width and thus a reduction of the diameter of the clamping means. The clamping element can also be a locking connection, e.g. in the form of a lever element functioning in the manner of a knee lever, or the like.

According to the invention, the clamping means comprises a first clamping region and a second clamping region. The first clamping region, extending particularly in the longitudinal direction, i.e. in the direction of the handlebar tube, serves for establishing a—preferably direct—connection of said additional grip element or barend to the handlebar tube. Herein, a clamping attachment is realized particularly on the outer side of the handlebar tube. Thus, according to a preferred embodiment, the first clamping region has an annular shape. Thus, in an additional grip element which e.g. is made fully of metal and is provided with an integrated clamping means, a metallic clamping region is arranged in abutment e.g. on an outer side of the like-wise metallic handlebar tube. Thereby, high clamping forces can be realized. This is required particularly in long barends so that, in situations of high stresses as occurring e.g. when riding the bicycle in open terrain, twisting of the barend on the handlebar is avoided. Long barends have a length of particularly more than 10 cm, in some cases even more than 14 cm.

Optionally, the additional grip element is made from different materials, it being preferred that the clamping means is formed as a metal part which is connected to a barend made of plastic. Optionally, it is possible to also provide regions made of a softer material, e.g. a softer plastic, on the outer side of the barend.

The second clamping region of the clamping means as provided by the invention is connected to the grip element preferably at a sleeve of the grip element. By connecting the grip element, via the second clamping region, to the additional grip element such as e.g. the barend, a holding attachment of the grip element is realized. This has the advantage that, by use of just one clamping means, not only the additional grip element but also the grip element itself can be fixed to the handlebar tube.

According to the invention, a securing element is arranged in the second clamping region between the grip element and the additional grip element. By the provision of a securing element, it is possible e.g. to avoid a lateral displacement of the grip element, i.e. a displacement of the grip element inwardly relative to the handlebar. According to a preferred embodiment, the securing element establishes a form-locking connection between the clamping means and the grip element and thus between the additional grip element and the grip element.

According to a particularly preferred embodiment of the invention, an undercut is provided, in the assembled state, between the securing element and the grip element and/or between the securing element and the clamping means in the longitudinal direction. Thus, in the longitudinal direction of the bicycle grip and respectively the longitudinal direction of the handlebar tube, there is formed at least one step by which the corresponding undercut is realized. In this manner, it is prevented in a simple manner that a relative movement could occur between the additional grip element and the grip element in the longitudinal direction. Particularly, it is prevented that the grip element could slide out of the clamping means of the additional grip element. Especially if the grip element is of the type comprising a wing-shaped projection for supporting the heel of the hand, such a slide-out effect in the axial direction would be dangerous because it would then allow the grip element to rotate on the handlebar. This would cause a safety risk which, however, is avoided by the inventive configuration of the bicycle grip.

A further advantage of the provision of the securing element—which advantage is independent from the prevention of axial displacement—resides in that, during the assembly process, the positional relationship between the grip element and the additional grip element can be unambiguously defined. The securing element is formed in such a manner and respectively cooperates with the clamping means and/or the grip element in such a manner that an audible locking engagement will be performed. During assembly, this has the advantage that, first, the grip element will be mounted to the handlebar tube and, then, the additional grip element and respectively the barend will be plugged on from the outside until the securing element has been audibly locked into position. In this manner, it is guaranteed that the grip element and the additional grip element will fully overlap each other in the second clamping region and that the grip element is thus safely connectible to the additional grip element. Further, it is possible that, prior to mounting the additional grip element onto the handlebar tube, one can adjust the grip element in its position on the handlebar tube in such a manner that the handlebar tube will extend by a defined length beyond the grip element. During the connecting process, particularly during the audible lock-in of the securing element, it is therefore further safeguarded that the first clamping region will be brought into complete abutment on the outer side of the handlebar tube and, thus, there is made use of the maximum available clamping surface of the first clamping region. In this manner, it is safeguarded that the high forces and moments occurring in the first clamping region will be transmitted onto the handlebar tube. In cases where the clamping surface in the first clamping region should not be fully used, only small forces and moments could be transmitted. This could then lead to twisting of the additional grip element and respectively the barend in situations of high stresses.

According to a particularly preferred embodiment, the securing element is a separate component, i.e. a component which is not tightly or integrally connected to the clamping means or the grip element. Preferably, the securing element is formed as a partial ring, preferably as a slotted metal ring. Such a component can be easily produced and is light-weighted.

Upon assembly, the preferably ring-shaped securing element will extend into a recess which according to a preferred embodiment is also ring-shaped and which is provided in the second clamping region of the clamping means. In case of a securing element which is not shaped as a ring, there are correspondingly provided one or a plurality of recesses adapted to the shape of the securing element. It is preferred that a further recess, which according to a preferred embodiment is also ring-shaped, is provided in the grip element and is arranged opposite to the ring-shaped recess of the clamping means.

Thus, in the assembled condition, the preferably ring-shaped securing element will extend into the two ring-shaped recesses and grooves, respectively.

Alternatively, the securing element can be formed integrally with the clamping means or the grip element or be tightly connected thereto. In the latter arrangement, it is possible to form the securing element as a locking element or a lug. In the assembled condition, said lug extends e.g. into a groove arranged opposite thereto. Preferably, the lug will be locked into the groove in the assembled condition. This locking can again occur in such a manner that it will be audible to the user during the assembly process, thus allowing for safe assembly. Preferably, in this embodiment, there are provided a plurality of lugs or locking elements which are arranged along a ring and respectively along the circumference, said lugs or locking elements being respectively connected to or formed integrally with the corresponding component and, in the assembled condition, being in locking engagement with an opposite groove.

According to a preferred embodiment, the grip element comprises a preferably cylindrical projection extending into the second clamping region while preferably fully covering the second clamping region. Said cylindrical projection can be a sleeve, preferably made of a harder material such as e.g. harder plastic, which preferably extends along the whole length of the grip element.

It is particularly preferred that, in the assembled state, an opening of the handlebar tube is closed by a cover element. With preference, according to the invention, said cover element is connected to or, preferably, formed integrally with the clamping means and respectively the additional grip element. Especially in case of an integral configuration, it is thus precluded that the cover element becomes lost, e.g. if the bicycle should happen to fall to the ground. The provision of a securing element makes it possible to form the cover element integrally with the additional grip element because, during the assembly process, there will be no necessity to check from the outside whether the additional grip element has been completely shifted onto the handlebar tube. According to a preferred embodiment, correct assembly will be reliably signaled to the user by a corresponding audible sound emitted by the securing element.

Particularly in case of a ring-shaped, e.g. separate securing element, a further advantage resides in the possibility of fine adjustment between the additional grip element and the grip element. Thus, both elements can be rotated on the handlebar tube independently from each other and thus be adjusted in a manner which is agreeable to the user, both with regard to the position of the elements relative to each other and with regard to the respective individual position. This fine adjustment can be carried out in a state where the grip has been fully assembled. For instance, the grip can already have been slightly fixed with the aid of the clamping element, e.g. a screw, so that the additional grip element as well as the grip element can now still be rotated on the handlebar only with difficulty. Complete demounting for changing the position of the additional grip element and of the grip element on the handlebar tube will not be required.

### BRIEF DESCRIPTION OF THE DRAWINGS

A full and enabling disclosure of the present invention, including the best mode thereof, enabling one of ordinary skill in the art to carry out the invention, is set forth in greater detail in the following description, including reference to the accompanying drawing in which

FIG. 1 is a schematic plan view of a preferred embodiment of the inventive bicycle handlebar grip prior to assembly,

FIG. 2 is a schematic plan view of the securing element,

FIG. 3 is a schematic plan view of the bicycle handlebar grip in the assembled state, and

FIG. 4 is a schematic lateral view of the additional grip element as viewed in the direction of the arrow IV in FIG. 4.

### DETAILED DESCRIPTION OF PREFERRED EMBODIMENTS

The bicycle handlebar grip of the invention comprises a grip element 10 which can be plugged onto a handlebar tube 12. In the illustrated embodiment, grip element 10 comprises a sleeve 14 preferably made of harder plastic. Connected to said sleeve 14 is a grip portion 16 surrounding the sleeve 14, said grip portion 16 being tightly connected to sleeve 14, e.g. by vulcanizing. In the illustrated embodiment, grip portion 16 is formed with a projection 18 oriented in the direction towards the cyclist. This wing-shaped projection serves to support the heel of the hand. Said sleeve 14 further comprises a slot 20 extending in the longitudinal direction 22 of grip element 10. Said slot 20 is provided on that side of sleeve 14 which in the assembled state is facing outwards, i.e. in the left direction in FIG. 1. Slot 20 extends in the longitudinal direction along a cylindrical projection 24 of sleeve 14 which projects from grip portion 16. In the illustrated embodiment, slot 20 extends also into that region of sleeve 14 which is surrounded by grip portion 16.

Said protruding cylindrical projection 24 serves for clamping attachment of grip element 10 to handlebar tube 12.

In the illustrated embodiment, for establishing said clamping attachment of grip element 10 to handlebar tube 12, an additional grip element 26 such as e.g. a barend, is connected to or formed integrally with a clamping means 28. Said clamping means 28 is formed in the manner of a clamping ring and in the assembled state will nearly completely surround the handlebar tube 12. Clamping means 28 comprises a slot 30 (FIG. 4). For generating the required clamping force, a clamping element such as e.g. a screw 32 will be tightened. Thereby, the width of slot 30 and thus the inner diameter of clamping means 28 will be enlarged.

Clamping means 28 comprises a first clamping region 34 (FIG. 1) as well as a second clamping region 36. In the assembled state, said first clamping region 34 is located in direct abutment on an outer side 38 of handlebar tube 12. Effected thereby is a direct clamping attachment of the barend 26 to handlebar tube 12. In this manner, e.g. if the barend 26 is fully made of metal, it is made possible to apply high clamping forces. Alternatively, the additional grip element 26 can be of a multi-part design, to the effect that the—in FIG. 1—upper part of barend 26 which leads away from handlebar tube 12 is e.g. made of plastic, and that there is provided a clamping means made of metal which is connected to said part.

The second clamping region 36 which, as first clamping region 34, has a cylindrical shape, comprises a larger inner diameter than the first clamping region 34. The inner diameter of the second clamping region 36 substantially corresponds to the outer diameter of the cylindrical projection 24 of sleeve 14. The width of the second clamping region 36 substantially correponds to the length by which the projection 24 extends beyond grip portion 16.

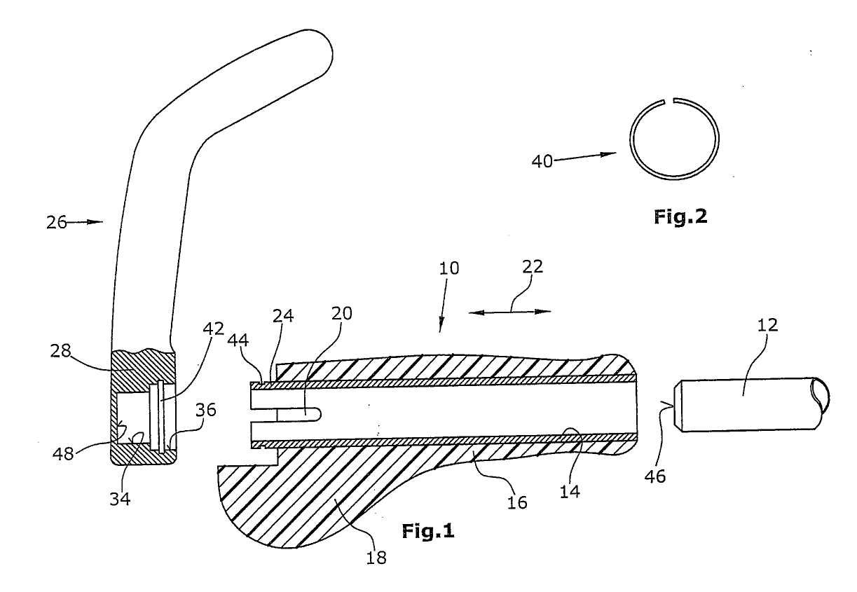

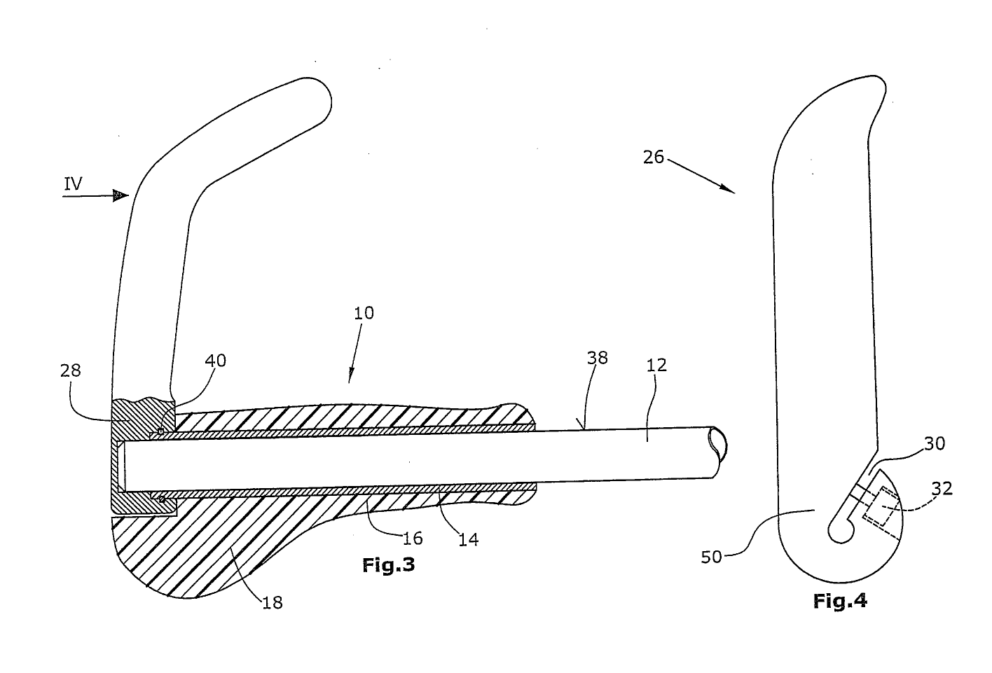

For receiving a securing element 40 formed as a slotted metal ring (FIG. 2), it is provided, in the illustrated embodiment, that an annular recess or groove 42 is formed in the second clamping region 36, and that an annular groove 44 is formed in said projection 24. In the assembled state, said two grooves 42,44 are arranged opposite to each other (FIG. 3) and accommodate the securing ring 40.

Thus, for assembly, the grip element 10 will in a first step be mounted on the handlebar tube 12 so that the handlebar tube 12 will extend beyond the projection 24 of sleeve 14. In the resultant arrangement, handlebar tube 12 will extend beyond projection 24 by an amount corresponding to the width of the first clamping region 34.

In the next step, the securing element 40, which is slightly biased to the outside, will be inserted into the groove 42 in the first clamping region 34. This step is followed by shifting the additional grip element 26 onto the end of handlebar tube 12 extending beyond projection 24, and onto projection 24 itself. As soon as the additional grip element 26 has been completely shifted into position, the securing ring 40 will snap into groove 44 of cylindrical projection 24. At the same time, an outer side 46 of handlebar tube 12 will abut an inner side 48 (FIG. 1) of clamping means 28.

The inner side 48 of clamping means 28 is formed by a cover element 50 (FIG. 4) which in the illustrated embodiment is provided integrally with the additional grip element 26. In an additional grip element 26 made of a plurality of materials wherein the upper part, i.e. the part extending away from the handlebar tube 12, is preferably made of plastic, said cover element 50 is preferably also made of plastic and is formed integrally with said part of the additional grip element 26.

Although the invention has been described and illustrated with reference to specific illustrative embodiments thereof, it is not intended that the invention be limited to those illustrative embodiments. Those skilled in the art will recognize that variations and modifications can be made without departing from the true scope of the invention as defined by the claims that follow. It is therefore intended to include within the invention all such variations and modifications as fall within the scope of the appended claims and equivalents thereof.

What is claimed is:

1. A bicycle handlebar grip, particularly for trekking bikes and mountain bikes, comprising:
a grip element to be mounted on a handlebar tube,
an additional grip element arranged at an angle to the grip element, and
a clamp attached to said additional grip element,
said clamp comprising a first clamping region for connection to the handlebar tube and a second clamping region for connection to the grip element,
wherein
a securing element is arranged between the grip element and the clamp in said second clamping region.

2. The bicycle handlebar grip according to claim 1, wherein, in the assembled state, said securing element is effective to provide a form-locking connection between the grip element and the clamp.

3. The bicycle handlebar grip according to claim 1, wherein, in the assembled state, an undercut exists in the longitudinal direction between the securing element and the grip element and/or between the securing element and the clamp.

4. The bicycle handlebar grip according to claim 1, wherein the securing element is formed as a separate component.

5. The bicycle handlebar grip according to claim 1, wherein the securing element is formed as a partial ring.

6. The bicycle handlebar grip according to claim 1, wherein the securing element is formed as a slotted metal ring.

7. The bicycle handlebar grip according to claim 1, wherein the clamp comprises, in the second clamping region, a part-ring-shaped recess having the securing element projecting thereinto in the assembled state.

8. The bicycle handlebar grip according to claim 1, wherein the grip element comprises a ring-shaped recess having the securing element projecting thereinto in the assembled state.

9. The bicycle handlebar grip according to claim 1, wherein the grip element comprises a cylindrical projection which in the assembled state extends into the second clamping region and fully covers the second clamping region.

10. The bicycle handlebar grip according to claim 9, wherein said cylindrical projection is a part of an inner sleeve extending along the complete length of the grip element.

11. The bicycle handlebar grip according to claim 1, wherein a cover element is provided for covering an opening of the handlebar tube in the assembled state, said cover element being formed integrally with the additional grip element.
